(19) United States
(12) Patent Application Publication
(10) Pub. No.: US 2008/0153684 A1
(43) Pub. Date: Jun. 26, 2008

(54) Machine and Method For Producing Cardboard Tubes

(76) Inventor: Fabio Perini, Viareggio (Lucca) (IT)

Correspondence Address: MCGLEW & TUTTLE, PC, P.O. BOX 9227, SCARBOROUGH STATION, SCARBOROUGH, NY, 10510-9227, US

(21) Appl. No.: 10/567,591

(22) PCT Filed: Feb. 1, 2005
(86) PCT No.: PCT/IT05/00046

§ 371 Date: Feb. 6, 2006

(30) Foreign Application Priority Data
Feb. 24, 2004 (IT) FI2004A000046

(51) Int. Cl. B31C 3/04; B31C 11/00

(52) U.S. Cl. 493/287

(57) ABSTRACT

Method for producing cardboard tubes by winding a plurality of ribbons (U, L) onto a spindle (1), a preset number of said ribbons (U, L) being glued in correspondence of the lower surface thereof, characterized in that a predetermined amount of supplementary quick setting glue is applied on the lower surface of the last ribbon (U) destined to be wound on the spindle (1), in proximity to at least a longitudinal edge (BU) of said ribbon (U) forming a corresponding stripe of quick setting glue (G) astride of a section (ST) of the same ribbon interested by a subsequent cutting action executed downstream of the spindle (1).

The present invention relates to a machine and a method for producing cardboard tubes.

It is known that a machine for producing cardboard tubes basically comprises:
means for continuously feeding two or more ribbons made of paper or similar material, at least one ribbon being provided with a predetermined amount of glue in correspondence of one of its sides, the ribbons being drawn from corresponding bobbins which are supported by the feeding means;
belt type means, which are positioned downstream of said feeding means, for winding and advancing said ribbons onto a spindle, forming a plurality of spirals which are overlapped and staggered according to a predetermined staggering step, so that the tube results from the reciprocal overlapping and gluing of the ribbons which are spirally wound on the spindle;
means, which are positioned downstream of said spindle, for cutting the continuous tube into elements having a predetermined length.

The first ribbon, i.e. the ribbon destined to directly contact the spindle, is not glued, to avoid its adhesion to the spindle surface.

In practice, the belt means, which are positioned onto the spindle downstream of with respect to the feeding direction of the ribbons, drawn the ribbons by exerting on them a traction force which is directed towards the spindle and, while it is forming, the tube made by the overlapped spiral ribbons advances and rotates about the longitudinal axis of the spindle.

The intervention rate of the cutting means depends on the advancing speed of the tube onto the spindle and on the predetermined length of the elements obtained from the tube.

Such a machine is described in WO 95/10400 and WO 95/10399.

One of the main drawbacks deriving from of such machines lies in a cleavage of the tube in correspondence of the cut sections. This drawback is even more evident when the operative speed of the machine increases.

The main aim of the present invention is to eliminate the said drawback.

This result has been achieved, according to the invention, by adopting the principles of the independent claims. Further characteristics being set forth in the dependent claims.

Thanks to the present invention, it is possible to increase the operative speed of the machine, i.e. the feeding speed of the ribbons and, consequently, the tubes producing speed, without the aforesaid cleavage effect. Furthermore, a machine according to the present invention is relatively simple to make, cost-effective and reliable even after a prolonged service life and it may also be realized by modifying the existing machines, without adversely affecting the functionality thereof, at a cost which is very low when compared with the advantages which are obtained.

These and other advantages and characteristics of the invention will be best understood by anyone skilled in the art from a reading of the following description in conjunction with the attached drawings given as a practical exemplification of the invention, but not to be considered in a limitative sense, wherein:

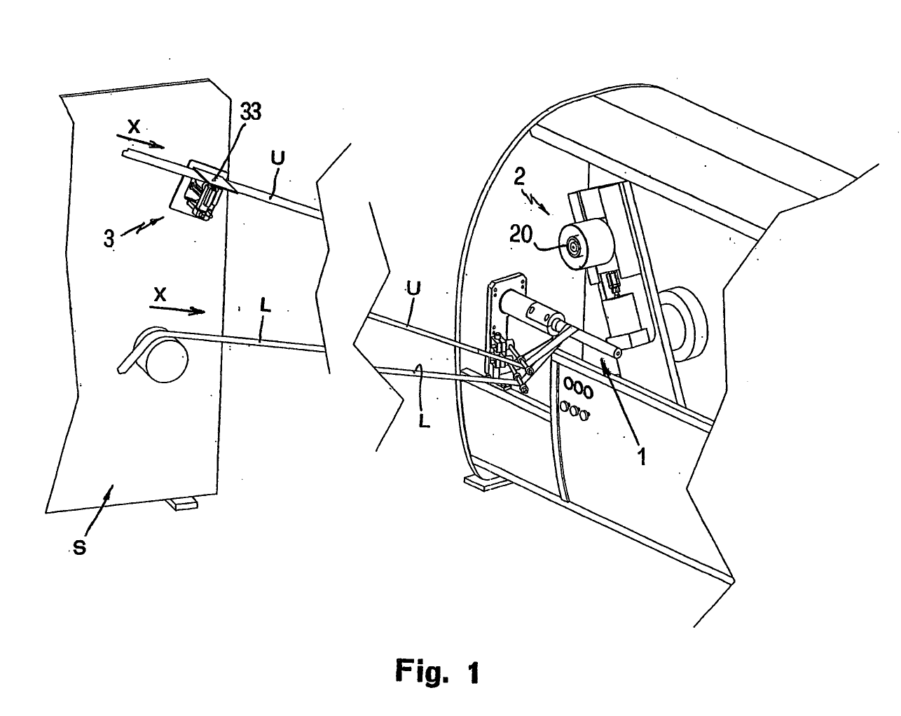

FIG. 1 is a partial perspective view of a machine according to the present invention;

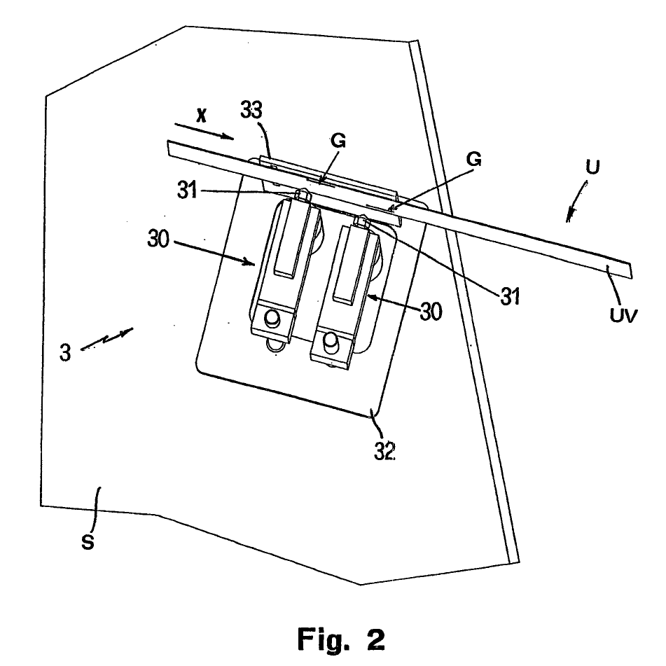

FIG. 2 shows a particular, represented in perspective view from the bottom, relating to the injectors for the application of the glue on the lower surface of the second ribbon treated in the machine of FIG. 1;

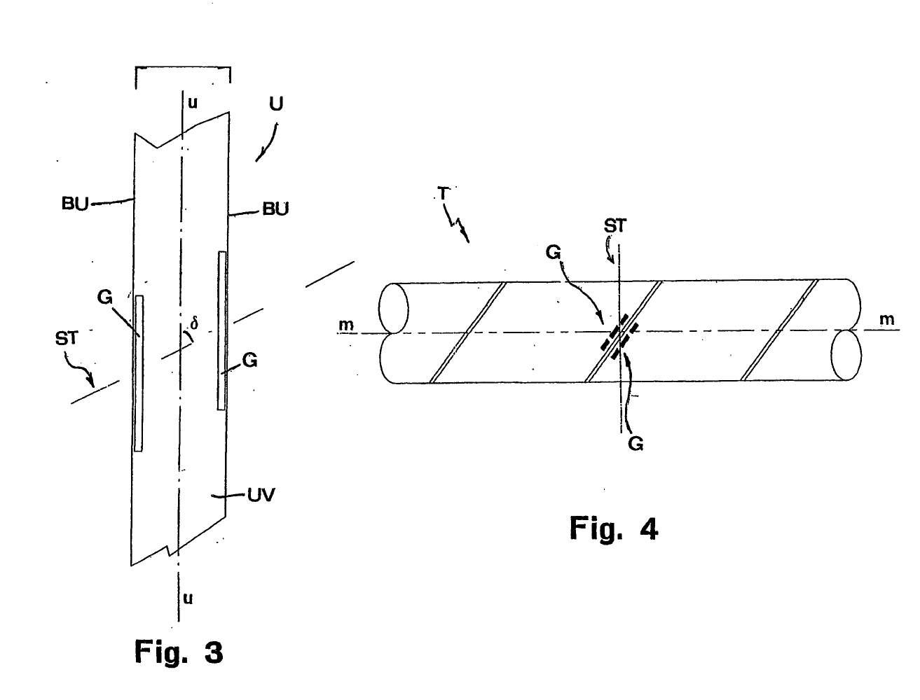

FIG. 3 is a schematic view of the lower surface of a portion of the second ribbon treated in the machine of FIG. 1, in which, in particular, is shown the relative position of two gluing lines;

FIG. 4 is a schematic plan view of a tube portion obtained by the spiral winding of two ribbons of the same width, in which, in particular, are shown the two gluing lines of FIG. 3;

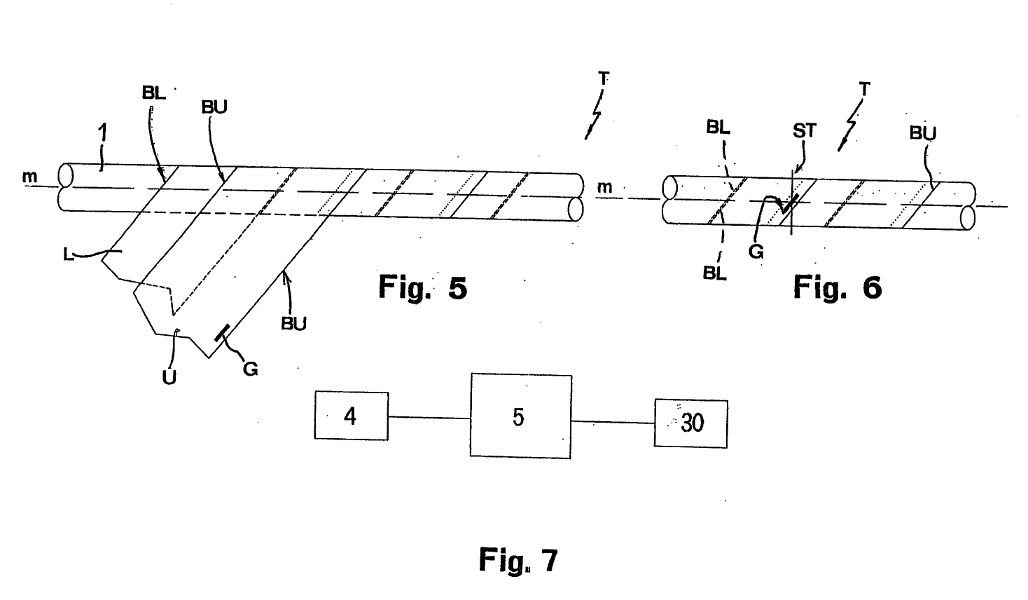

FIG. 5 shows a schematic plan view of two ribbons of different width at the entrance of the section of the machine comprising the spindle: in the figure is shown a gluing line applied on the lower surface of the wider upper ribbon, even if this line is on the other face of the sheet;

FIG. 6 is a schematic plan view of a tube portion obtained by the winding of the two ribbons of FIG. 5;

FIG. 7 is a simplified block diagram of the control system driving the means for applying a supplementary amount of quick setting glue;

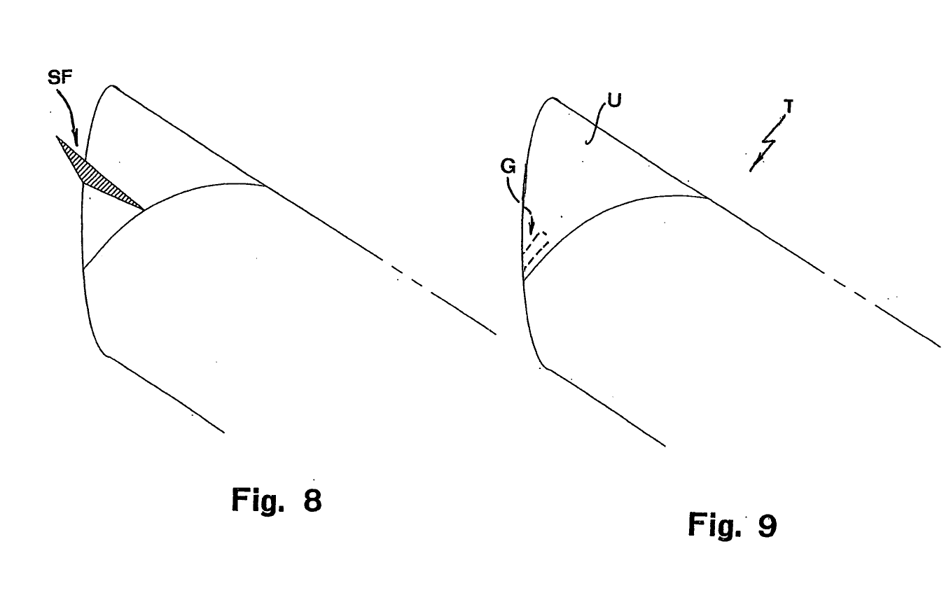

FIG. 8 is a schematic representation relating to the cleavage of a conventional cardboard tube in correspondence of an end section;

FIG. 9 is a representation similar to that of FIG. 8 but referred to a cardboard tube obtained according to the present invention.

Reduced to its basic structure, reference being made to the enclosed drawings, a machine according to the present invention comprises, similarly to the conventional machines:
a structure (S) supporting a plurality of bobbins (not shown for sake of simplicity) from which are unwound more ribbons (U, L) of paper or paper-like material;
a plurality of gluing rolls (not shown for sake of simplicity) which are disposed downstream of said bobbins in respect to the advancing direction (X) of the ribbons (U, L) along a wall of said structure (S) and which are feed by corresponding tanks (also not shown for sake of simplicity) containing liquid glue, for applying a predetermined amount of glue on the lower surface of each of the advancing ribbons (U, L), with the exception of the first ribbon (L), i.e. with the exception of the ribbon (L), the lower surface of which is destined to the direct contact with a spindle (1) disposed downstream, on which the tubes are formed;
a spindle (1) which is longitudinally developed along the direction of the tube to be produced, the ribbons (U, L) being wound onto said spindle forming a plurality of superimposed and staggered spirals;
belt means (2), with relevant motor means (20), for spirally winding said ribbons (U, L) onto the spindle (1) and advancing the forming tube along the longitudinal axis (m-m) of the same spindle;
cutting means (not shown for sake of clarity) for subdividing the tube (T) into portions or tubular elements having a predetermined length.

As stated above, the feeding and gluing means acting on the ribbons (U, L), the winding means and the means for cutting the tube (which results from the overlapping and reciprocal gluing of the ribbons spirally wound onto the spindle) are known to those skilled in the art and, therefore, it is omitted a more detailed description thereof. The gluing of the lower surface of the ribbons (U, L) is made, according to a known technique, upstream of the spindle (1), by means of liquid glue, the liquid glue exploiting its adhesive power in a relatively long time to avoid that it became dry along the path between the gluing station (i.e. the station where the tanks containing the liquid glue are positioned) and the spindle (1).

The machine comprises means (3) for applying a predetermined amount of supplementary glue of the quick setting type to the lower surface (i.e. the surface destined to look at the spindle 1) of at least one of the ribbons which are wound onto the spindle (1) and, more precisely, to the lower surface of the last ribbon, i.e. that ribbon the upper surface of which defines the external surface of the tube.

Said means (3) are connected to a tank for the quick setting glue which, for sake of simplicity, is not shown in the enclosed drawings.

The wording “quick setting glue” denotes a glue having a high adhesive power acting in a short time.

With reference to the examples shown in the enclosed drawings, the means (3) distribute the quick setting glue on the lower surface of the second ribbon (U), which is the last ribbon and travels along a path overhanging the advancing path of the first ribbon (L), the tube being constituted by only two ribbons spirally wound and superimposed.

When the ribbons are three instead of two, said means (3) distribute the glue on the lower surface of the third ribbon, i.e. always on the lower surface of the last ribbon.

According to the example shown in the drawings, said means (3) comprise a distributor apt to distribute “hot melt” glue, whose body is solid to said structure (S), in such a manner to result downstream of said gluing rolls and upstream of the spindle (1). Said distributor (3) comprises a couple of injectors (30) fixed to a plate (32) solid to the structure (S) near the exit section of the latter, with the respective nozzles (31) directed to the lower surface (UV) of the ribbon to be treated (in the example, the lower surface of the second ribbon U). In correspondence with said injectors (30), the ribbon (U) to be treated is kept in guide by a wing (33) of the said plate (32) oriented parallel to the advancing direction (X) of the ribbon and which is spaced from the nozzles (31) of the two injectors (30) in such a manner that the ribbon (U) passes through the space between the wing (33) and the nozzles (31), with the upper surface turned towards the wing (33) and the lower surface (UV) turned towards the nozzles (31). Said injectors (30) are disposed and acting in such a manner to distribute a preset amount of quick setting glue (for example, a “hot melt” glue) in correspondence of at least one of the longitudinal edges of the lower surface (UV) of the ribbon (U) advancing towards the spindle (1). Preferably, the injectors (30) distribute a preset amount of quick setting glue in proximity to both the longitudinal edges (BU) of the last ribbon (U) if this has the same width of the underlying ribbon (L) and in correspondence of only one edge (BU) if the upper ribbon (U) has a greater width than the lower ribbon (L). Obviously, also in the second case it is possible to distribute quick setting glue on both the longitudinal edges of the upper ribbon or last ribbon (U). Referring to the first of the two examples, i.e. when the two ribbons (U) and (L) have the same width, the injectors (30) are activated, for a preset time, in such a manner to apply two stripes of quick setting glue (G) on the lower surface (UV) of the last ribbon (U) astride of a section (ST) subsequently involved by the action of the cutting means acting downstream of the spindle (1). Said section (ST) is, as more clearly shown in FIG. 3, inclined of a preset angle (δ) in respect to the longitudinal axis (u-u) of the ribbon (U). Said angle (δ) is the complementary of the angle formed by the plan projection of the longitudinal axis of each ribbon (L, U) with the longitudinal axis (m-m) of the spindle (1) when the ribbons are wound on the latter (see FIG. 4); furthermore, this angle corresponds to the angle formed by each stripe of quick setting glue (G) with said section (ST).

As shown in FIG. 4, when the tube formed by the spirals of the ribbons (U, L) wound on the spindle (1) is cut, since the cut is operated in correspondence of the section interested by the stripes of quick setting glue (G), both the stripes (G) are cut and a portion of each of them is both upstream and downstream of the cutting section. Therefore, when the cut is executed, both upstream and downstream of the section (ST) the corresponding edges of the ribbons (U, L) are strongly anchored each other. In this way, it is avoided the cleavage phenomenon characteristic of the tubes produced by the conventional machines, schematically represented in FIG. 8, where “SF” denotes an edge of the last ribbon detached from the underlying ribbon in correspondence of an end section of the tube, i.e. in correspondence of the section interested by said cut. On the contrary, as shown in FIG. 9. a tube (T) according to the present invention is exempt from such phenomenon.

Referring to the second example, since the last ribbon (U), i.e. the ribbon whose upper surface defines the outer surface of the tube (T), is wider than the underlying ribbon (L), it can be sufficient to distribute a preset amount of supplementary quick setting glue in correspondence of only one of its longitudinal edges (BU). In the scheme of FIG. 5, the glue stripe (G) is represented with continuous line, even if it is on the opposite face of the sheet and it is in proximity to the right edge (BU) of the ribbon (U). In the scheme of FIG. 6, the discontinuous lines marked by the reference (BL) correspond to the coinciding edges of the lower ribbon (L), spirally wound on the spindle (1) and the glue stripe (G) is represented with continuous line, even if it is on the lower surface of the last ribbon (U), for a better highlight of the same.

When only one supplementary glue stripe (G) is to be applied, then it is activated only the corresponding injector (30) instead of both the injectors.

Therefore the two injectors (30) are placed in such a way to have the respective nozzle (31) disposed on the plane defined by the said section (ST) and are activated at the same time for applying two stripes of quick setting glue (G) astride of the section (ST).

The distance between the nozzles (31) of the two injectors (30) depends on the width (LA) of the ribbon (U).

The activation of the injectors (30) is operated on the basis of the length of the completed tubes to be produced, i.e. in function of the length of the tubes obtained from the cutting of the ribbons wound and glued spirally on the spindle (1). For example, calling “LA” the width of the ribbon (U), “D” the diameter of the spindle and “LT” the length of the tube to be produced, the injectors (30) are activated for a preset time when in correspondence of them passes a portion of ribbon (U) of length equal to LT*D*π/LA. The activation time of the injectors is preset on the basis of the desired length of each stripe of supplementary quick setting glue (G).

The control of the amount of ribbon (U) which advances in front of the nozzles (31) of the injectors (30) can be operated by means of an encoder (4) mounted on the axis of an idly roll having a surface covered by friction-material; the ribbon passes on this surface, around the roll and determines the rotation of the same roll. This control system, disposed upstream of the means (3), is well known in the technical field. Said encoder (4) is connected with a programmable electronic unit (5) apt to receive the data from the encoder (4) for processing them on the basis of the formula previously indicated and apt to operate the activation of the injectors (30) when the preset length value is reached. The structure and the working of said electronic control means are Known by the technicians of the industrial automation and, therefore, aren't described in detail.

According to present invention, an operational method involves to apply, in addition to the glue normally used for obtaining the reciprocal attachment of the two ribbons (U, L) spirally wound, a preset amount of supplementary quick setting glue (for example, a “hot melt” glue) in correspondence of the interface between the penultimate ribbon and the last one, astride of a section (ST) subsequently interested by the action of the cutting means downstream of the spindle (1).

Practically, all the construction details may vary in any equivalent way as far as the shape, dimensions, elements disposition, nature of the used materials are concerned, without nevertheless departing from the scope of the adopted solution idea and, thereby, remaining within the limits of the protection granted to the present patent for invention.

1. Method for producing cardboard tubes by winding a plurality of ribbons onto a spindle, a preset number of said ribbons being glued in correspondence of the lower surface thereof, a predetermined amount of supplementary quick setting glue being applied on the lower surface of the last ribbon destined to be wound on the spindle, in proximity to at least a longitudinal edge of said ribbon forming a corresponding stripe of quick setting glue astride of a section of the same ribbon interested by a subsequent cutting action executed downstream of the spindle, characterized in that the application of said at least one stripe of supplementary glue is operated at intervals corresponding to a preset length of said last ribbon.

2. Method according to claim 1, characterized in that said stripe of quick setting glue is distributed in proximity to both the longitudinal edges of said ribbon.

3. Method according to claim 1, characterized in that the quick setting glue is a “hot melt” glue.

4. Method according to claim 1, characterized in that said stripes of quick setting glue are distributed by two injectors acting along an advancing path of the said ribbon upstream of the spindle.

5. Method according to claim 1, characterized in that all the ribbons are of the same width.

6. Method according to claim 1, characterized in that the ribbons are of different width.

7. Method according to claim 1, characterized in that said preset length depends on the length of the tubes to be obtained.

8. Cardboard tubes producing machine, comprising a structure supporting feeding means for a plurality of ribbons of paper or paper-like material, a spindle on which said ribbons, glued in correspondence of the respective lower surfaces, with the exception of the first ribbon which is destined to the direct contact with the spindle, are wound, means for moving said ribbons and winding them on said spindle, the machine comprising means disposed and acting along a path of the ribbon, the upper surface of which is destined to define the outer surface of a tube, said means distributing a stripe of supplementary quick setting glue in proximity to almost a longitudinal edge of the lower surface of said ribbon astride of a section of the latter interested by a subsequent cutting operation downstream of the spindle, characterized in that said means are operated at intervals corresponding to a present length of said last ribbon.

9. Machine according to claim 8, characterized in that said distributor means of supplementary quick setting glue comprise a couple of injectors fixed to a plate that is fixed to the structure near the exit section of the latter, with the respective nozzles directed to the lower surface of the ribbon to be treated, the latter being kept in guide, in correspondence of the injectors, by a wing of the said plate oriented parallel to the advancing direction of the ribbon and which is spaced from the nozzles of the two injectors, the ribbon passing through the space between the wing and the nozzles, with the upper surface turned towards the wing and the lower surface turned towards the nozzles.

10. Machine according to claim 8, characterized in that it comprises programmable electronic means apt to measure the length of the portions of ribbon in correspondence of said means distributing the supplementary quick setting glue: said means being driven by programmable electronic means.
